(19) United States
(12) Patent Application Publication
(10) Pub. No.: US 2025/0070496 A1
(43) Pub. Date: Feb. 27, 2025

(54) ELECTRICAL CONNECTOR

(71) Applicant: Changchun Jetty Automotive Technology Co., Ltd., Jilin (CN)

(72) Inventors: Chao WANG, Jilin (CN); Keyuan LI, Jilin (CN)

(21) Appl. No.: 18/725,270

(22) PCT Filed: Dec. 28, 2022
(86) PCT No.: PCT/CN2022/142643

§ 371 Date: Jun. 28, 2024

(30) Foreign Application Priority Data
Dec. 30, 2021 (CN) 202111665882.X

(51) Int. Cl. H01R 13/24; H01R 13/432; H01R 13/631

(52) U.S. Cl. CPC H01R 13/2457; H01R 13/432; H01R 13/631

(57) ABSTRACT

An electrical connector includes: a housing, which has a first opening and a second opening, in which the first opening and the second opening are spaced apart, and a sidewall of the housing facing the first opening is provided with a first insertion portion; a first conductive unit is capable of being electrically connected to the first electrical connecting device and/or the second electrical connecting device, at least part of the first conductive unit is accommodated in the housing, and in a state where the first electrical connecting device and/or the second electrical connecting device is inserted into the housing via the first insertion portion from the outside of the housing, the first electrical connecting device and/or the second electrical connecting device is capable of being electrically connected to the at least part of the first conductive unit.

### CROSS REFERENCE TO RELATED APPLICATIONS

This application is a National Stage Entry of International Application No. PCT/CN2022/142643, filed Dec. 28, 2022, and claims priority to Chinese Patent Application No. 202111665882.X, entitled “electrical connector”, filed Dec. 30, 2021, the disclosures of which are incorporated herein by reference in their entireties.

### TECHNICAL FIELD

The present disclosure relates to the technical field of connectors, and particularly to an electrical connector.

### BACKGROUND

The electronic connector, generally also referred to as an electrical connector, is a conductor device used to connect two conductors that are on a circuit so that current or signals can flow from one conductor to the other.

In the prior art, the conductive unit of the electrical connector generally employs the following two modes. One is a cylindrical-electrical-connecting-device jack-type conductive unit, which is processed by machining, with complicated production processes, high cost, and limited current-carrying capacity; meanwhile, due to the limitation of the outer size of the conductive unit, the size of such connector is larger than that of a sheet-type conductive unit connector with the same specification, which cannot meet the market demand for high performance, low cost and light weight of parts and components. The other is a sheet-type conductive unit, which usually employs a form that a snap spring wraps a reed, and after the snap spring and the reed are fixed, the conductive unit can only be matched with the electrical connecting device from a single angle, so that the utilization rate of the conductive unit is low, which is not conducive to the mass production of the conductive unit.

### SUMMARY

The present disclosure provides an electrical connector, which can realize mating with an electrical connecting device from at least two angles, so as to improve the utilization rate and the use flexibility of the electrical connector.

The present disclosure can be implemented by the following technical solutions:

The present disclosure provides an electrical connector, including:
a housing, which has a first opening for insertion of a first electrical connecting device and a second opening for insertion of a second electrical connecting device, in which the first opening and the second opening are spaced apart, and a sidewall of the housing facing the first opening is provided with a first insertion portion;
a first conductive unit, which is capable of being electrically connected to the first electrical connecting device and/or the second electrical connecting device, and at least part of the first conductive unit is accommodated in the housing, and in a state where the first electrical connecting device or the second electrical connecting device is inserted into the housing via the first insertion portion from the outside of the housing, the first electrical connecting device or the second electrical connecting device is capable of being electrically connected to the accommodated at least part of the first conductive unit.

Compared with the prior art, the present disclosure has the following characteristics and advantages:

In the electrical connector of the present disclosure, the sidewall of the housing facing the first opening is provided with the first insertion portion, and in a state where the first electrical connecting device and/or the second electrical connecting device is inserted into the housing via the first insertion portion from the outside of the housing, the first electrical connecting device and/or the second electrical connecting device can be electrically connected to the accommodated at least part of the first conductive unit. Thus, the first electrical connecting device and the second electrical connecting device not only can be respectively inserted into the housing from the first opening and the second opening and electrically connected to the first conductive unit, but also can be inserted from the first insertion portion and electrically connected to the first conductive unit. Therefore, through the above arrangement, the electrical connector of the present disclosure can realize that the first electrical connecting device and/or the second electrical connecting device is matched with the electrical connector from at least two angles (e.g., 90 degrees and 180 degrees).

### BRIEF DESCRIPTION OF THE DRAWINGS

In order to illustrate the technical solutions in the embodiments of the present disclosure more clearly, the drawings to be used in the description of the embodiments will be briefly introduced below. Obviously, the drawings involved in the following description illustrate only some embodiments of the present disclosure, and those of ordinary skill in the art may obtain other drawings from these drawings without paying any inventive effort.

FIG. 1 illustrates a schematic diagram of a three-dimensional structure of a housing of an electrical connector according to the present disclosure;

FIG. 2 illustrates a schematic diagram of a three-dimensional structure of an electrical connector according to the present disclosure, in which a first electrical connecting device and a second electrical connecting device are respectively inserted into a first opening and a second opening of the electrical connector;

FIG. 3 illustrates an enlarged view of Part A in FIG. 2;

FIG. 4 illustrates a schematic diagram of a three-dimensional structure of a housing of an electrical connector in an incomplete molded state according to the present disclosure;

FIG. 5 illustrates a schematic diagram of a three-dimensional structure of an electrical connector according to the present disclosure, in which a first electrical connecting device and a second electrical connecting device are respectively inserted into a first insertion portion and a second opening of the electrical connector;

FIG. 6 illustrates a schematic diagram of a three-dimensional structure of an electrical connector according to the present disclosure;

FIG. 7 illustrates a structural diagram of a combination of a first conductive unit and a second conductive unit of an electrical connector according to the present disclosure;

FIG. 8 illustrates a structural diagram of a first conductive unit and a second conductive unit of an electrical connector in a separated state according to the present disclosure;

FIG. 9 illustrates a schematic diagram of a three-dimensional structure of a combination of two first conductive units of an electrical connector according to the present disclosure;

FIG. 10 illustrates a schematic diagram of a three-dimensional structure of second conductive units of an electrical connector in a separated state according to the present disclosure;

FIG. 11 illustrates a top view of a structure of an electrical connector according to the present disclosure; and

FIG. 12 illustrates a cross-sectional view taken along line B-B in FIG. 11.

Reference numerals:

1: housing; 11: first opening; 12: second opening; 13: first insertion portion; 14: second insertion portion; 15: mounting opening; 16: clamping component; 161: first housing elastic arm; 1611: first free end; 162: second housing elastic arm; 1621: second free end; 17: first side; 171: protrusion; 18: second side; 181: dovetail groove;

2: first conductive unit; 21: first elastic arm; 211: first warped section; 212: first connecting section; 22: first gap; 23: first terminal body; 24: second elastic arm; 241: second warped section; 242: second connecting section; 25: second gap; 26: elastic arm connecting piece;

3: fixing component; 31: first fixing portion; 32: first fixing mating portion;

4: support portion;

5: second conductive unit; 51: first elastic reinforcing portion; 511: protruding portion;

512: positive pressure portion; 52: second terminal body; 53: second elastic reinforcing portion; 531: reinforcing arm; 5311: abutting section; 5312: contact section;

6: first fixing piece;

7: first fixing mating piece;

8: first electrical connecting device;

9: second electrical connecting device.

### DESCRIPTION OF THE EMBODIMENTS

The implementations of the present disclosure are described below through specific embodiments, and those skilled in the art can readily obtain other advantages and effects of the present disclosure from the disclosure of the specification. In addition, the present disclosure may also be carried out or applied through other different specific embodiments, and various modifications and changes may be made within the protection scope of the present disclosure.

Based on the above advantages, in order to further understand the present disclosure, the exemplary embodiments are disclosed below, and the technical solutions of the present disclosure and the achieved effects are described in detail as follows with reference to the drawings and the reference numerals.

To facilitate the understanding of the electrical connector of the present disclosure, the application scenarios of the electrical connector of the present disclosure is described first. The electrical connector of the present disclosure is applied to connect two conductors (e.g., electrical connecting devices).

In the present disclosure, the term “cantilever beam” means that one end of a beam is provided with a fixed support and the other end of the beam is a free end.

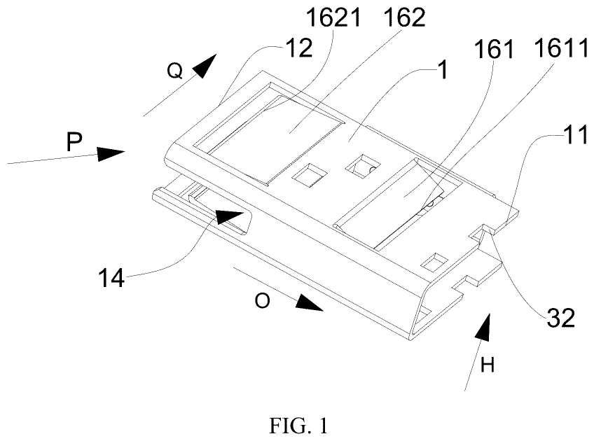

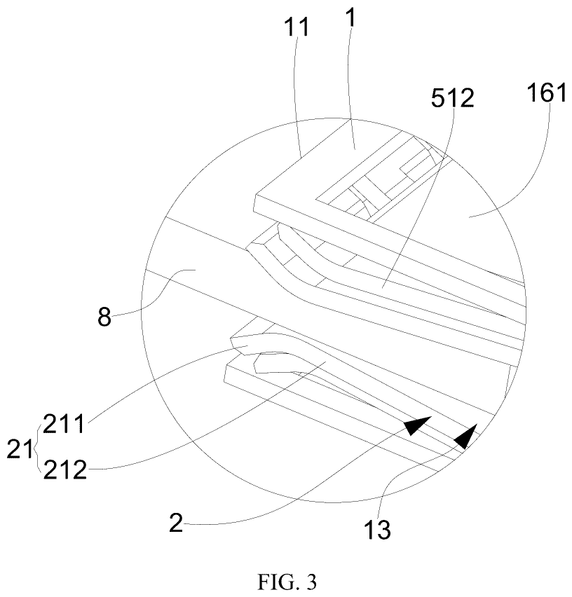

As illustrated in FIGS. 1 to 3, an electrical connector provided by the present disclosure includes a housing 1 and a first conductive unit 2; the housing 1 has a first opening 11 for insertion of a first electrical connecting device 8 and a second opening 12 for insertion of a second electrical connecting device 9, in which the first opening 11 and the second opening 12 are spaced apart, and a sidewall of the housing 1 facing the first opening 11 is provided with a first insertion portion 13; the first conductive unit 2 is capable of being electrically connected to the first electrical connecting device 8 and/or the second electrical connecting device 9, in which at least part of the first conductive unit 2 is accommodated in the housing 1, and in a state where the first electrical connecting device 8 or the second electrical connecting device 9 is inserted into the housing 1 via the first insertion portion 13 from the outside of the housing 1, the first electrical connecting device 8 or the second electrical connecting device 9 is capable of being electrically connected to the accommodated at least part of the first conductive unit 2.

In the electrical connector of the present disclosure, the sidewall of the housing 1 facing the first opening 11 is provided with the first insertion portion 13, and in a state where the first electrical connecting device 8 or the second electrical connecting device 9 is inserted into the housing 1 via the first insertion portion 13 from the outside of the housing 1, the first electrical connecting device 8 or the second electrical connecting device 9 can be electrically connected to the accommodated at least part of the first conductive unit 2. Thus, the first electrical connecting device 8 and the second electrical connecting device 9 not only can be respectively inserted into the housing 1 from the first opening 11 and the second opening 12 and electrically connected to the first conductive unit 2, but also can be inserted from the first insertion portion 13 at the first opening 11 and electrically connected to the first conductive unit 2. Therefore, through the above structure, the electrical connector of the present disclosure can realize that the first electrical connecting device 8 and/or the second electrical connecting device 9 is matched with the electrical connector from at least two different angles.

Specifically, the housing 1 may be a hollow cuboid structure, the first insertion portion 13 may be a notch provided on the housing 1 and communicated with the first opening 11, and at least part of the first conductive unit 2 is provided in the housing 1, for example, by means of welding, adhesion, threaded connection, or clamping. In the actual use, the first electrical connecting device 8 and the second electrical connecting device 9 may be inserted into the housing 1 from the first opening 11 and the second opening 12, respectively, so that the first electrical connecting device 8 and the second electrical connecting device 9 are electrically connected to the first conductive unit 2 of the housing 1. Optionally, the first electrical connecting device 8 or the second electrical connecting device 9 may also be inserted into the housing 1 via the first insertion portion 13 communicated with the first opening 11, so that the first electrical connecting device 8 or the second electrical connecting device 9 inserted via the first insertion portion 13 can be electrically connected to the first conductive unit 2 of the housing 1.

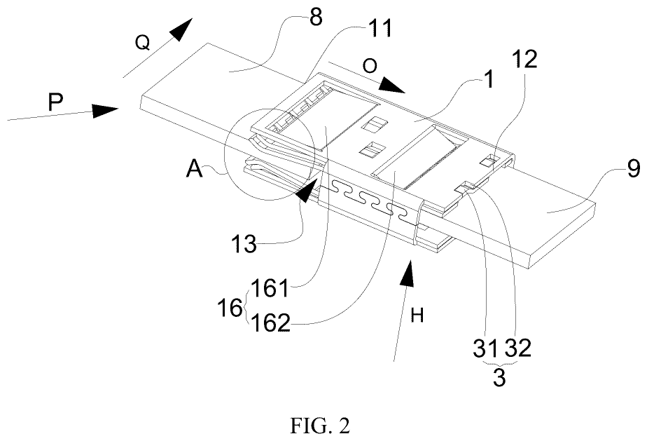

Further, as illustrated in FIGS. 1 and 2, the sidewall of the housing 1 facing the first opening 11 is further provided with a second insertion portion 14, and the second insertion portion is disposed opposite to the first insertion portion 13 in a direction perpendicular to a direction O in which the first electrical connecting device 8 or the second electrical connecting device 9 is inserted into the first opening 11. Specifically, the second insertion portion 14 may also be a notch provided on the housing 1 and communicated with the first opening 11.

In the present disclosure, by disposing the first insertion portion 13 and the second insertion portion 14 both of which are communicated with the first opening 11 on the sidewall of the housing 1 facing the first opening 11, the first electrical connecting device 8 or the second electrical connecting device 9 can be inserted into the housing 1 not only from the first opening 11, the second opening 12 or the first insertion portion 13, but also from the second insertion portion 14, thereby realizing multi-angle electrical connections with the first conductive unit 2, and further enriching the modes for mating the first electrical connecting device 8 or the second electrical connecting device 9 with the electrical connector.

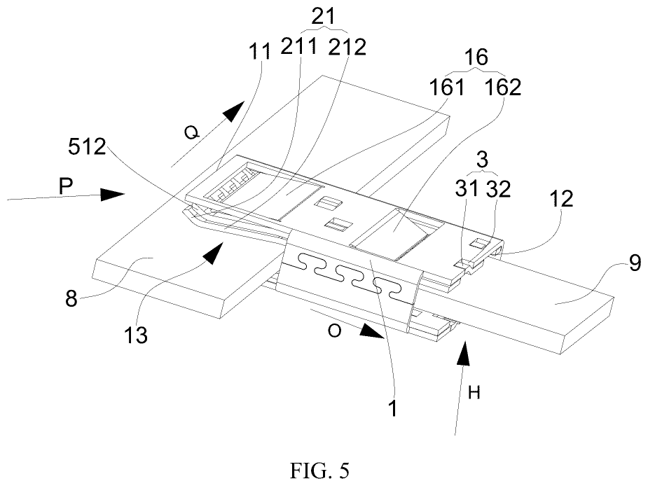

The housing 1 may be made of a plastic material or a metal material, and may adopt a material with good or poor electrical conductivity, such as steel or a steel-containing material. The first insertion portion 13 and/or the second insertion portion 14 of the present disclosure, on the one hand, makes it possible for the first electrical connecting device 8 and the second electrical connecting device 9 to be respectively inserted into the housing 1 in the direction O, and on the other hand, and also makes it possible for the first electrical connecting device 8 or the second electrical connecting device 9 to be inserted from a lateral direction of the housing 1, as illustrated in FIG. 5. Of course, optionally, the first electrical connecting device 8 or the second electrical connecting device 9 may also be inserted in an incline direction P of the housing 1, thereby further enriching the modes for mating the first electrical connecting device 8 or the second electrical connecting device 9 with the electrical connector. On the other hand, the present disclosure is more convenient for processing, and for example, an end of the first opening 11 of the housing 1 may be directly cut to form the first insertion portion 13 and/or the second insertion portion 14.

In a feasible embodiment, the first insertion portion 13 or the second insertion portion 14 may also be a hole formed on the sidewall of the housing 1 and provided close to the first opening 11 or the second opening 12 of the housing 1, such as a square through-hole. During implementation, a peripheral wall of the hole may have a function of limiting the first electrical connecting device 8 or the second electrical connecting device 9. In addition, in order to achieve the effect of waterproof and dustproof, in some embodiments, a waterproof plate or a dustproof plate may be hinged on a peripheral wall of the first insertion portion 13 and/or the second insertion portion 14 on the housing 1, and by disposing the waterproof plate or the dustproof plate at the first insertion portion 13 or the second insertion portion 14 in a sealed manner, the effect of waterproof or dustproof can be achieved.

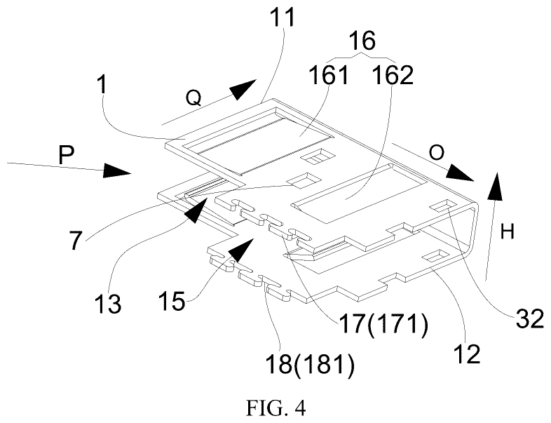

Further, as illustrated in FIG. 4, the housing 1 has a mounting opening 15 for placement of the first conductive unit 2, and in a state where the first conductive unit 2 is inserted into the housing 1 via the mounting opening 15, a sidewall of the housing 1 at the mounting opening 15 can be bent to close the mounting opening 15. By providing the mounting opening 15, the first conductive unit 2 can be quickly placed in the housing 1, so that the assembly is simple and disassembly is convenient.

Specifically, the housing 1 is shaped as a plate before being molded, and is a substantially ⊏-shaped structure after being bent in a width direction Q of the plate, and an opening of the ⊏-shaped structure is the mounting opening 15. During the assembly of the electrical connector, the first conductive unit 2 is directly placed into the housing 1 from the outside of the housing 1 via the mounting opening 15, and then the mounting opening 15 is closed.

In the present disclosure, the housing 1 before being molded includes a first side 17 and a second side 18 which are oppositely disposed in the width direction Q. One of the first side 17 and the second side 18 is provided with a dovetail-shaped protrusion 171, for example, by means of welding, adhesion or integral stamping, and the other of the first side 17 and the second side 18 is provided with a dovetail groove 181 having a shape matched with the shape of the protrusion 171, and the protrusion 171 may be in snap-fit with the dovetail groove 181.

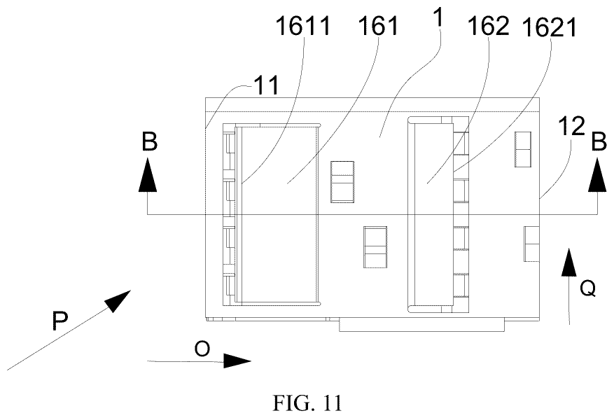

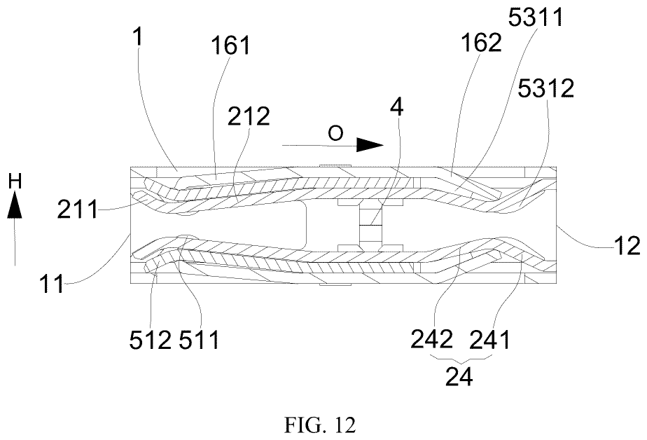

Further, as illustrated in FIGS. 11 and 12, the housing 1 further includes a clamping component 16 which provides a pre-tightening force to the first conductive unit 2. By providing the clamping component 16, the first electrical connecting device 8 or the second electrical connecting device 9 inserted into the housing 1 can be clamped more tightly, thereby ensuring the connection reliability of the electrical connector in a vibration environment.

In the present disclosure, the clamping component 16 includes at least one first housing elastic arm 161 located at the first opening 11 and at least one second housing elastic arm 162 located at the second opening 12; and the first housing elastic arm 161 includes a first free end 1611 that can be extended into the housing 1 and abutted against the first conductive unit 2; and the second housing elastic arm 162 includes a second free end 162 that can be extended into the housing 1 and abutted against the first conductive unit 2.

Specifically, the first housing elastic arm 161 and the second housing elastic arm 162 may be located at the same side of the housing 1, such as located at an upper surface of the housing 1 as illustrated in FIG. 1; alternatively, the first housing elastic arm 161 and the second housing elastic arm 162 may be located at different sides of the housing 1, and for example, the first housing elastic arm 161 is located on an upper surface of the housing 1 and the second housing elastic arm 162 is located on a lower surface of the housing 1.

In an example where the first electrical connecting device 8 is inserted into the housing 1 via the first opening 11 and electrically connected to the first conductive unit 2, and the second electrical connecting device 9 is inserted into the housing 1 via the second opening 12 and electrically connected to the first conductive unit 2, when the clamping component 16 is provided, as the first electrical connecting device 8 is inserted into the first opening 11 and due to the first electrical connecting device 8 has a certain thickness, as illustrated in FIG. 12, the first electrical connecting device 8 enables the first conductive unit 2 to move toward an inner wall of the adjacent housing 1 in a thickness direction H of the housing 1. At this time, the first housing elastic arm 161 located at the first opening 11 has a function of clamping the first electrical connecting device 8. Similarly, the second housing elastic arm 162 clamps the second electrical connecting device 9 inserted into the second opening 12 more tightly.

A pressure applied by the first housing elastic arm 161 on the first electrical connecting device 8 is of 0.3 N to 95 N; and a pressure applied by the second housing elastic arm 162 on the second electrical connecting device 9 is of 0.3 N to 95 N.

In order to verify the influence of the pressure applied by the first housing elastic arm 161 to the first electrical connecting device 8 on the contact resistance therebetween, or the influence of the pressure applied by the second housing elastic arm 162 to the second electrical connecting device 9 on the contact resistance therebetween, the inventor carries out targeted tests. Taking the pressure applied by the first housing elastic arm 161 to the first electrical connecting device 8 as an example, the inventor selects the first housing elastic arm 161 with the same shape and the same size and the first electrical connecting device 8 with the same shape and the same size, and designs different pressures between the first housing elastic arm 161 and the first electrical connecting device 8 to observe the contact resistances therebetween.

The test method of the contact resistance is to adopt a micro-resistance measuring instrument to measure the resistance at the contact position between the first housing elastic arm 161 and the first electrical connecting device 8, and read the value on the micro-resistance measuring instrument. In this embodiment, the contact resistance less than 50 μΩ is an ideal value.

TABLE 1
Influence of different pressures between the housing elastic arm
and the electrical connecting device on the contact resistance
Pressure applied by the first housing elastic arm
161 to the first electrical connecting device 8 (N)

| | | | | | | | | | | | | | | | | | |
|---|---|---|---|---|---|---|---|---|---|---|---|---|---|---|---|---|---|
| 0.1 | 0.2 | 0.3 | 0.5 | 1 | 5 | 10 | 20 | 30 | 40 | 50 | 60 | 70 | 80 | 90 | 95 | 100 | 105 |

Contact resistance (μΩ)

| | | | | | | | | | | | | | | | | | |
|---|---|---|---|---|---|---|---|---|---|---|---|---|---|---|---|---|---|
| 64 | 56 | 49 | 43 | 40 | 37 | 35 | 33 | 30 | 27 | 22 | 18 | 13 | 12 | 11 | 10 | 9 | 9 |

As can be seen from Table 1, when the pressure between the first housing elastic arm 161 and the first electrical connecting device 8 is less than 0.3 N, the contact resistance therebetween is higher than the ideal value because the bonding force is too small, which does not meet the requirement. When the pressure between the first housing elastic arm 161 and the first electrical connecting device 8 is greater than 95 N, the contact resistance does not decrease obviously, but the material selection and processing are more difficult, and the first electrical connecting device 8 will be damaged if the pressure is too high. Therefore, the inventor sets that the pressure applied by the first housing elastic arm 161 to the first electrical connecting device 8 is of 0.3 N to 95 N; and the pressure applied by the second housing elastic arm 162 to the second electrical connecting device 9 is of 0.3 N to 95 N.

In addition, the inventor finds that when the pressure between the first housing elastic arm 161 and the first electrical connecting device 8 is greater than 0.5 N, the contact resistance therebetween is good, and tends to decrease quickly. When the pressure between the first housing elastic arm 161 and the first electrical connecting device 8 is less than 50 N, it is convenient to manufacture, mount and use the electrically-conductive elastic sheet with a low cost. Therefore, the inventor exemplarily chooses that the pressure applied by the first housing elastic arm 161 to the first electrical connecting device 8 is of 0.5 N to 50 N; and the pressure applied by the second housing elastic arm 162 to the second electrical connecting device 9 is of 0.5 N to 50 N.

According to an embodiment of the present disclosure, as illustrated in FIGS. 5 to 7 and 1, the electrical connector further includes a fixing component 3 which is used to fix the housing 1 and the first conductive unit 2, and is provided between the housing 1 and the first conductive unit 2. By providing the fixing component 3, it not only facilitates the assembly and disassembly of the first conductive unit 2, but also achieves the function of limiting the first conductive unit 2.

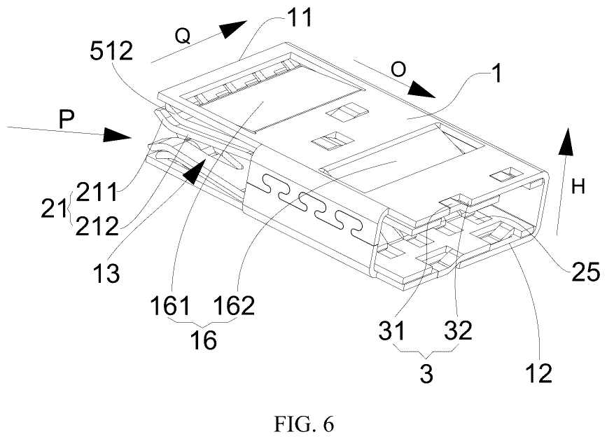

In a feasible embodiment, as illustrated in FIG. 6, the fixing component 3 includes a first fixing portion 31 and a first fixing mating portion 32 which are detachably connected to each other; and the first fixing portion 31 is a first convex piece provided on the first conductive unit 2 by means of welding, adhesion, threaded connection, clamping or integral stamping, and the first fixing mating portion 32 is a first concave piece provided on the housing 1.

In another feasible embodiment, the fixing component 3 includes a first fixing portion 31 and a first fixing mating portion 32 which can be detachably connected to each other; and the first fixing portion 31 is a first convex piece provided on the housing 1 by welding, adhesion, threaded connection, clamping or integral stamping, and the first fixing mating portion 32 is a first concave piece provided on the first conductive unit 2.

By providing the first fixing portion 31 and the first fixing mating portion 32, the structure is simple, and the first conductive unit 2 and the housing 1 can be quickly assembled and disassembled by hands without using any other tool (e.g., an adhesive tape or a welding rod).

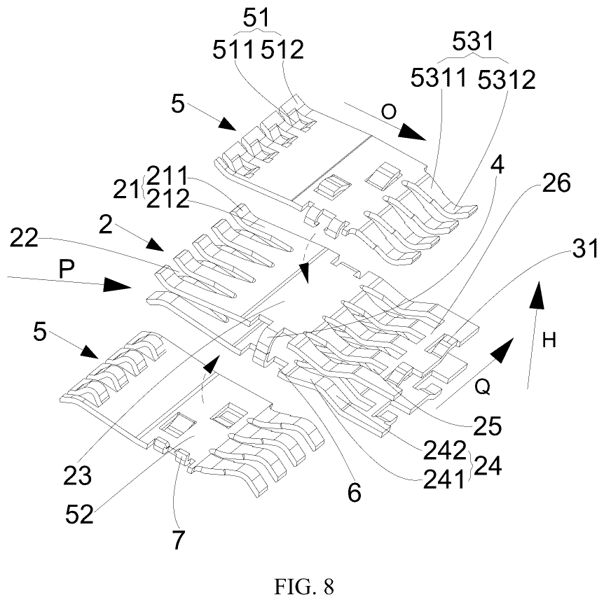

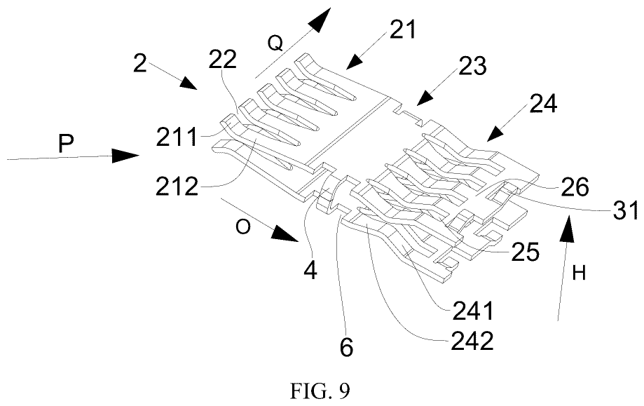

According to an embodiment of the present disclosure, as illustrated in FIGS. 8 and 9, the housing 1 is provided therein with two first conductive units 2, and the two first conductive units are spaced apart in a thickness direction H of the housing 1. By providing the two first conductive units 2, the first electrical connecting device 8 and the second electrical connecting device 9 can be clamped bidirectionally. Compared with the electrical connector with only one first conductive unit 2, in the case of a sheet-type electrical connecting device as an example, by providing the two first conductive units 2, both sides of a sheet-type electrical connecting device can be in contact with the first conductive units 2, thereby improving the reliability of the electrically connection between the electrical connecting device and the first conductive units 2.

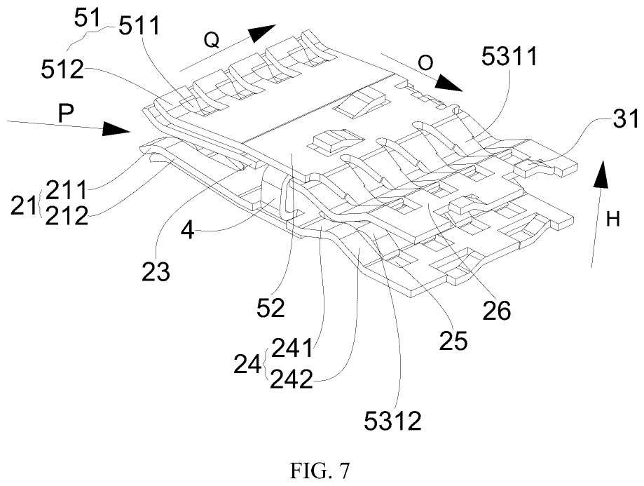

Further, as illustrated in FIGS. 7 to 9, a support portion 4 of strip-shaped is connected between the two first conductive units, and is located at the same side of the two first conductive units 2. By providing the support portion 4, the processing speed of the first conductive units 2 can be improved, that is, before the housing 1 is molded, the processing of the two first conductive units 2 on the same plane can be completed simultaneously by folding the two first conductive units 2 through the support portion 4. In addition, since the support portion 4 is located at the same side of the first conductive units 2 disposed up and down it is also convenient to process the two first conductive units 2 and improve the processing speed. Furthermore, since the support portion 4 is connected at the same side of the two first conductive units 2, each of the first conductive units 2 serves as a cantilever beam structure, that is, under the action of an external pressure, the two first conductive units 2 can approach each other and deform in the thickness direction H of the housing 1, so that the volume is reduced, and then the two first conductive units 2 can be conveniently placed into the housing 1 via the mounting opening 15 without any interference with the housing 1.

In the present disclosure, as illustrated in FIG. 9, the first conductive unit 2 includes a plurality of first elastic arms 21 which are located at the first opening 11 and disposed at intervals in a direction perpendicular to the direction Q in which the first electrical connecting device 8 or the second electrical connecting device 9 is inserted into the first opening, with a first gap 22 between every adjacent two of the first elastic arms 21.

By disposing at least two first elastic arms 21 at intervals in the direction perpendicular to the direction Q in which the first electrical connecting device 8 or the second electrical connecting device 9 is inserted into the first opening, materials are saved and the production and manufacturing costs are reduced. In addition, since the materials are reduced, the contact area with the first electrical connecting device 8 is decreased, so that the contact temperature rise (or called a temperature threshold) and the contact resistance can be effectively reduced.

Specifically, a width of the first gap 22 is 1% to 100% of a width of the first elastic arm 21.

In order to verify the influence of the spacing distance of the adjacent first gaps 22 on the contact resistance of the electrical connector, the inventor selects the electrical connector consisting of the first conductive unit 2 with the same shape and size and the housing 1 with the same shape and size, and the first electrical connecting device 8 with the same shape and size and the second electrical connecting device 9 with the same shape and size, and connects the electrical connector with the second electrical connecting device 9 to observe the contact resistance between the first electrical connecting device 8 and the electrical connector.

The test method of the contact resistance is to adopt a micro-resistance measuring instrument to measure the resistance at the contact position between the first electrical connecting device 8 and the electrical connector, and read the value on the micro-resistance measuring instrument. In this embodiment, the contact resistance less than 50 μΩ is an ideal value.

TABLE 2
Influence of the spacing distance (width) of the first gaps 22 on the contact resistance
between the first electrical connecting device 8 and the electrical connector structure
Ratio of the spacing distance (width) of the first
gaps 22 to the width of the first elastic arm 21 (%)

| | | | | | | | | | | | | | | | | |
|---|---|---|---|---|---|---|---|---|---|---|---|---|---|---|---|---|
| 0.3 | 0.5 | 0.8 | 1 | 10 | 20 | 30 | 40 | 50 | 60 | 70 | 80 | 90 | 100 | 103 | 105 | 110 |

Contact resistance (μΩ)

| | | | | | | | | | | | | | | | | |
|---|---|---|---|---|---|---|---|---|---|---|---|---|---|---|---|---|
| 3 | 5 | 10 | 16 | 22 | 26 | 28 | 30 | 34 | 36 | 40 | 44 | 47 | 49 | 53 | 56 | 59 |

As can be seen from Table 2, when the ratio of the spacing distance (width) of the first gaps 22 to the width of the first elastic arm 21 is greater than 100%, the contact resistance is greater than 50 μΩ, which does not meet the requirement. In addition, the existing processing mode of the electrical connector structure is stamping or cutting, and if the spacing distance (width) of the first gaps 22 is too narrow, the processing is difficult. Due to the above reasons, the spacing distance (width) of the first gaps 22 is determined as 1% to 100% of the width of the first elastic arm 21.

Further, as illustrated in FIG. 9, each of the first elastic arms 21 includes a first warped section 211 and a first connecting section 212 which are sequentially connected from the first opening 11 to the second opening 12, and the first warped section 211 is inclined toward an outer edge of the first opening 11.

By disposing the first warped section 211 inclined toward the outer edge of the first opening 11, the electrical connecting device inserted into the housing 1 via the first opening 11 can be in contact with the first conductive unit 2 more easily, and the electrical connecting device is clamped more tightly, thereby improving the strength of the connection between the electrical connecting device and the electrical connector, i.e., improving the reliability of the electrical connector in the use state. Moreover, since the first warped section 211 is inclined toward the outer edge of the first opening 11, the contact area between a joint between the first warped section 211 and the first connecting section 212 of the first conductive unit 2, and the electric connecting device is reduced, that is, the stressed area of the electric connecting device is reduced. During use, the stronger the pressure effect on the electric connecting device, the tighter the clamping of the electric connecting device, so that when inserting the electrical connecting device, the insertion force of the electrical connecting device can be relieved and dispersed to keep an appropriate insertion force, that is, the electrical connecting device can be more easily inserted.

Further, as illustrated in FIG. 9, the first conductive unit 2 further includes a plurality of second elastic arms 24 which are located at the second opening 12 and disposed at intervals in a direction perpendicular to the direction Q in which the first electrical connecting device 8 or the second electrical connecting device 9 is inserted into the second opening 12, with a second gap 25 between every adjacent two of the second elastic arms 24; and the plurality of second elastic arms 24 are connected to the plurality of first elastic arms 21 through a first terminal body 23.

According to the present disclosure, by disposing the plurality of second elastic arms 24 at intervals in a direction perpendicular to the direction Q in which the first electrical connecting device 8 or the second electrical connecting device 9 is inserted into the second opening 12, materials are saved and the production and manufacturing costs are reduced. In addition, since the materials are reduced, the contact area with the second electrical connecting device 9 is decreased, so that the contact temperature rise (or called a temperature threshold) and the contact resistance can be effectively reduced.

In an embodiment, a width of the second gap 25 is 1% to 100% of a width of the second elastic arm 24.

In order to verify the influence of the spacing distance of the adjacent second gaps 25 on the contact resistance of the electrical connector, the inventor selects the electrical connector consisting of the first conductive unit 2 with the same shape and size and the housing 1 with the same shape and size, and the first electrical connecting device 8 with the same shape and size and the second electrical connecting device 9 with the same shape and size, and connects the electrical connector with the first electrical connecting device 8 to observe the contact resistance between the second electrical connecting device 9 and the electrical connector.

The test method of the contact resistance is to adopt a micro-resistance measuring instrument to measure the resistance at the contact position between the second electrical connecting device 9 and the electrical connector, and read the value on the micro-resistance measuring instrument. In this embodiment, the contact resistance less than 50 μΩ is an ideal value.

TABLE 3
Influence of the spacing distance (width) of the second gaps 25 on the contact resistance
between the second electrical connecting device 9 and the electrical connector structure
Ratio of the spacing distance (width) of the second
gaps 25 to the width of the second elastic arm 24 (%)

| | | | | | | | | | | | | | | | | |
|---|---|---|---|---|---|---|---|---|---|---|---|---|---|---|---|---|
| 0.3 | 0.5 | 0.8 | 1 | 10 | 20 | 30 | 40 | 50 | 60 | 70 | 80 | 90 | 100 | 103 | 105 | 110 |

Contact resistance (μΩ)

| | | | | | | | | | | | | | | | | |
|---|---|---|---|---|---|---|---|---|---|---|---|---|---|---|---|---|
| 3 | 5 | 10 | 16 | 22 | 26 | 28 | 30 | 34 | 36 | 40 | 44 | 47 | 49 | 53 | 56 | 59 |

As can be seen from Table 3, when the ratio of the spacing distance (width) of the second gaps 25 to the width of the second elastic arm 24 is greater than 100%, the contact resistance is greater than 50 μΩ, which does not meet the requirement. In addition, the existing processing mode of the electrical connector structure is stamping or cutting, and if the spacing distance (width) of the second gaps 25 is too narrow, the processing is difficult. Due to the above reasons, the spacing distance (width) of the second gaps 25 is determined as 1% to 100% of the width of the second elastic arm 24.

Further, as illustrated in FIG. 9, each of the second elastic arms 24 includes a second warped section 241 and a second connecting section 242 which are sequentially connected from the second opening 12 to the first opening 11, and the second warped section 241 is inclined toward an outer edge of the second opening 12.

By disposing the second warped section 241 inclined toward the outer edge of the second opening 12, the electrical connecting device inserted into the housing 1 via the second opening 12 can be in contact with the first conductive unit 2 more easily, and the electrical connecting device is clamped more tightly, thereby improving the strength of the connection between the electrical connecting device and the electrical connector, i.e., improving the reliability of the electrical connector in the use state. Moreover, since the first warped section 211 is inclined toward the outer edge of the first opening 11, the contact area between the first conductive unit 2 and the electrical connecting device is reduced, that is, the stressed area of the electric connecting device is reduced. During use, the stronger the pressure effect on the electric connecting device, the tighter the clamping of the electric connecting device, so that when the electrical connecting device is inserted, the insertion force of the electrical connecting device can be relieved and dispersed to keep an appropriate insertion force, that is, the electrical connecting device can be more easily inserted.

In this embodiment, as illustrated in FIG. 9, the first conductive unit 2 further includes a strip-shaped elastic arm connecting piece 26, through which the plurality of second connecting sections 242 are connected to the inner wall of the housing 1.

By connecting the plurality of second connecting sections 242 to the inner wall of the housing 1 through the elastic arm connecting piece 26, the plurality of second elastic arms 24 are formed as a whole, thereby improving the stability of the connection between each of the second elastic arms 24 and the housing 1.

According to an embodiment of the present disclosure, as illustrated in FIGS. 7 and 9, the electrical connector further includes a second conductive unit 5, which is located between the first conductive unit 2 and the housing 1 and detachably connected to the first conductive unit 2. By providing the second conductive unit 5, the mechanical contact reliability and the electrical connection reliability between the electrical connecting device and the electrical connector are improved.

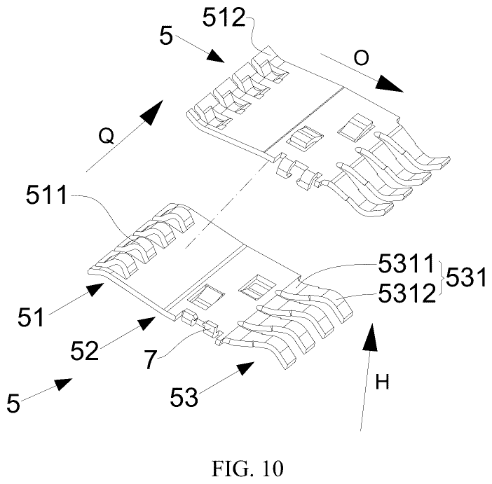

Further, as illustrated in FIGS. 8 and 10, the second conductive unit 5 is provided with a first fixing piece 6, and the first conductive unit 2 is provided with a first fixing mating piece 7 which can be connected to the first fixing piece 6 by snap-fit.

According to the present disclosure, by providing the first fixing piece 6 and the first fixing mating piece 7, the disassembly and assembly of the first conductive unit 2 and the second conductive unit 5 can be quickly completed, the structure is simple and the connection is firm.

In the present disclosure, as illustrated in FIG. 10, the second conductive unit 5 includes a first elastic reinforcing portion 51 which is located at the first opening 11 and provided with a plurality of protruding portions 511 that can pass through the first gaps 22 in the thickness direction H of the housing 1.

When the housing 1 is provided therein with two first conductive units 2, the plurality of protruding portions 511 of the first elastic reinforcing portion 51 can extend to a space between the two first conductive units 2 through the first gaps 22 in the thickness direction H of the housing 1. Therefore, when the electrical connecting device is inserted into the housing 1 via the first opening 11 or the first insertion portion 13, the strength of the connection between the electrical connecting device and the electrical connector can be further improved since the number of contact points of the electrical connecting device is increased, that is, the reliability of the connection between the electrical connecting device and the electrical connector in the use state is improved. In addition, by providing the protruding portions 511, the contact area between the first conductive unit 2 and the electrical connecting device is increased, and the current transmission distance is shortened, so that the temperature rise (or called a temperature threshold) and the contact resistance are effectively reduced.

The first conductive unit 2 and the second conductive unit 5 may be made of copper or a copper alloy, and specifically a tellurium copper alloy, a beryllium copper alloy, a phosphor bronze alloy, a lead brass alloy or a nickel copper alloy.

The tellurium copper alloy has a good electrical conductivity and an easy-cutting performance, which can ensure the electrical properties and improve the machinability.

The beryllium copper alloy has high hardness, elastic limit, fatigue limit and wear resistance, as well as good corrosion resistance, thermal conductivity and electrical conductivity, and does not produce sparks when being impacted.

The phosphor bronze alloy has better corrosion resistance and wear resistance, which can ensure good contact, high elasticity and excellent machining properties, and can quickly shorten the processing time of parts.

The lead brass alloy has high strength, compact and uniform structure, good corrosion resistance and excellent machining properties such as cutting, drilling and the like. The nickel copper alloy has good corrosion resistance, high hardness and good ductility, and can reduce the temperature coefficient of resistivity.

Further, as illustrated in FIG. 10, the first elastic reinforcing portion 51 further includes a positive pressure portion 512, which can be abutted against the plurality of first warped sections 211 adjacent thereto in the thickness direction H of the housing 1, and the plurality of protruding portions 511 are disposed on the positive pressure portion 512 at intervals in the width direction Q of the housing 1.

By providing the positive pressure portions 512, a mounting foundation can be provided for the respective protruding portions 511. In addition, since the positive pressure portion 512 can be abutted against the plurality of adjacent first warped sections 211 in the thickness direction H of the housing 1, when the electrical connecting device is inserted into the housing 1 via the first opening 11, or the first insertion portion 13 or the second insertion portion 14 and electrically connected to the first conductive unit 2, the first warped sections 211 move toward the inner wall of the adjacent housing 1 in the thickness direction H of the housing 1 since the electrical connecting device has a thickness. Therefore, by providing the positive pressure portions 512, a positive pressure can be provided for the first warped sections 211, so that the first warped sections 211 of the first conductive unit 2 are not easy to be bent and deformed, and the clamping force of the first conductive unit 2 on the electrical connecting device is improved.

As illustrated in FIG. 10, the second conductive unit 5 further includes a second elastic reinforcing portion 53 which is located at the second opening 12 and connected to the first elastic reinforcing portion 51 through a second terminal body 52, and the second elastic reinforcing portion 53 has a plurality of reinforcing arms 531 passing through the second gaps 25 in the thickness direction H of the housing 1.

When the housing 1 is provided therein with two first conductive units 2, the plurality of reinforcing arms 531 of the second elastic reinforcing portion 53 can extend to a space between the two first conductive units 2 through the second gaps 25 in the thickness direction H of the housing 1. Therefore, when the electrical connecting device is inserted into the space between the two first conductive units 2 of the housing 1 via the second opening 12, the strength of the connection between the electrical connecting device and the electrical connector can be further improved since the number of contact points of the electrical connecting device is increased, that is, the reliability of the connection between the electrical connecting device and the electrical connector in the use state is improved. In addition, by providing the plurality of reinforcing arms 531 extending to the space between the two first conductive units 2 through the second gaps 25 in the thickness direction H of the housing 1, the contact area between the first conductive unit 2 and the electrical connecting device is increased, and the current transmission distance is shortened, so that the temperature rise (or called a temperature threshold) and the contact resistance are effectively reduced.

Further, as illustrated in FIG. 10, each of the reinforcing arms 531 includes an abutting section 5311 and a contact section 5312 which are sequentially connected from the first opening 11 to the second opening 12, the abutting section 5311 can be abutted against the second elastic arm in the thickness direction H of the housing 1, and the contact section 5312 passes through the second gaps 25 in the thickness direction H of the housing 1.

By providing the abutting sections 5311, a positive pressure can be provided for the second connecting sections 242. When the electric connecting device is inserted into the housing 1 via the second opening 12 and electrically connected to the first conductive unit 2, the second connecting sections 242 move toward the inner wall of the adjacent housing 1 in the thickness direction H of the housing 1 since the electrical connecting device has a thickness. Therefore, by providing the abutting sections 5311, a positive pressure can be provided for the second connecting sections 242, so that the second connecting sections 242 of the first conductive unit 2 are not easy to be bent and deformed, and the clamping force of the first conductive unit 2 on the electrical connecting device is improved. By providing the contact sections 5312, the number of contact points with the electrical connecting device at the second opening 12 can be increased, the strength of the connection with the electrical connector can be further improved, that is, the reliability of the connection between the electrical connecting device and the electrical connector in the use state is improved. In addition, the contact area between the electrical connector and the electrical connecting device is increased, and the current transmission distance is shortened, so that the temperature rise (or called a temperature threshold) and the contact resistance are effectively reduced.

The above embodiments are only given as examples for the convenience of illustration, and the protection scope of the present disclosure should be based on the scope of claims, rather than being limited to the above embodiments.

1. An electrical connector, comprising:
a housing, which has a first opening for insertion of a first electrical connecting device and a second opening for insertion of a second electrical connecting device, wherein the first opening and the second opening are spaced apart, and a sidewall of the housing facing the first opening is provided with a first insertion portion;
a first conductive unit, which is capable of being electrically connected to the first electrical connecting device and/or the second electrical connecting device, wherein at least part of the first conductive unit is accommodated in the housing, and in a state where the first electrical connecting device or the second electrical connecting device is inserted into the housing via the first insertion portion from the outside of the housing, the first electrical connecting device or the second electrical connecting device is capable of being electrically connected to the accommodated at least part of the first conductive unit.

2. The electrical connector according to claim 1, wherein,
a sidewall of the housing facing the first opening is further provided with a second insertion portion, and the second insertion portion is disposed opposite to the first insertion portion in a direction perpendicular to a direction in which the first electrical connecting device or the second electrical connecting device is inserted into the first opening.

3. The electrical connector according to claim 1, wherein,
the housing has a mounting opening for placement of the first conductive unit, and in a state where the first conductive unit is inserted into the housing via the mounting opening, a sidewall of the housing at the mounting opening is capable of being bent to close the mounting opening.

4. The electrical connector according to claim 1, further comprising:
a fixing component, which is used to fix the housing and the first conductive unit, and is provided between the housing and the first conductive unit.

5. The electrical connector according to claim 4, wherein the electrical connector comprises one of: wherein,
the fixing component comprises a first fixing portion and a first fixing mating portion which are detachably connected to each other;
wherein the first fixing portion is a first convex piece provided on the first conductive unit, and the first fixing mating portion is a first concave piece provided on the housing; and
the fixing component comprises a first fixing portion and a first fixing mating portion which are detachably connected to each other;
wherein the first fixing portion is a first convex piece provided on the housing, and the first fixing mating portion is a first concave piece provided on the first conductive unit.

6. (canceled)

7. The electrical connector according to claim 1, wherein,
the housing is provided therein with two first conductive units, and the two first conductive units are spaced apart in a thickness direction of the housing.

8. The electrical connector according to claim 7, wherein,
a support portion is connected between the two first conductive units, and is located at the same side of the two first conductive units.

9. The electrical connector according to claim 1 wherein,
the first conductive unit comprises a plurality of first elastic arms which are located at the first opening and disposed at intervals in a direction perpendicular to a direction in which the first electrical connecting device or the second electrical connecting device is inserted into the first opening, with a first gap between every adjacent two of the first elastic arms.

10. The electrical connector according to claim 9, wherein, a width of the first gap is 1% to 100% of a width of the first elastic arm.

11. The electrical connector according to claim 9, wherein,
the first elastic arm comprises a first warped section and a first connecting section which are sequentially connected from the first opening to the second opening, and the first warped section is inclined toward an outer edge of the first opening.

12. The electrical connector according to claim 11, wherein,
the first conductive unit further comprises a plurality of second elastic arms which are located at the second opening and disposed at intervals in a direction perpendicular to a direction in which the first electrical connecting device or the second electrical connecting device is inserted into the second opening, with a second gap between every adjacent two of the second elastic arms;
wherein the plurality of second elastic arms are connected to the plurality of first elastic arms through a first terminal body.

13. (canceled)

14. The electrical connector according to claim 12, wherein,
the second elastic arm comprises a second warped section and a second connecting section which are sequentially connected from the second opening to the first opening, and the second warped section is inclined toward an outer edge of the second opening.

15. The electrical connector according to claim 14, wherein the first conductive unit further comprises:
an elastic arm connecting piece, through which the plurality of second connecting sections are connected to the housing.

16. The electrical connector according to claim 12, further comprising:
a second conductive unit, which is located between the first conductive unit and the housing and detachably connected to the first conductive unit.

17. The electrical connector according to claim 16, wherein,
the second conductive unit is provided with a first fixing piece, and the first conductive unit is provided with a first fixing mating piece which is capable of being connected to the first fixing piece by snap-fit.

18. The electrical connector according to claim 16, wherein the second conductive unit further comprises:
a first elastic reinforcing portion, which is located at the first opening and provided with a plurality of protruding portions that are capable of passing through the first gaps in a thickness direction of the housing.

19. The electrical connector according to claim 18, wherein the first elastic reinforcing portion further comprises a positive pressure portion, which is capable of being abutted against the plurality of first warped sections adjacent thereto in a thickness direction of the housing, and the plurality of protruding portions are disposed on the positive pressure portion at intervals in a width direction of the housing.

20. The electrical connector according to claim 18, wherein the second conductive unit further comprises:
a second elastic reinforcing portion, which is located at the second opening and connected to the first elastic reinforcing portion through a second terminal body, wherein the second elastic reinforcing portion has a plurality of reinforcing arms passing through the second gaps in the thickness direction of the housing.

21. The electrical connector according to claim 20, wherein,
the reinforcing arm comprises an abutting section and a contact section which are sequentially connected from the first opening to the second opening, the abutting section is capable of being abutted against the second elastic arm in the thickness direction of the housing, and the contact section passes through the second gaps in the thickness direction of the housing.

22. The electrical connector according to claim 1, wherein the housing further comprises:
a clamping component, which provides a pre-tightening force to the first conductive unit;
wherein the clamping component comprises at least one first housing elastic arm located at the first opening and at least one second housing elastic arm located at the second opening;
wherein the first housing elastic arm comprises a first free end that is capable of being extended into the housing and abutted against the first conductive unit; and
the second housing elastic arm comprises a second free end that is capable of being extended into the housing and abutted against the first conductive unit.

23. (canceled)
